(19) United States
(12) Patent Application Publication
(10) Pub. No.: US 2026/0325374 A1
(43) Pub. Date: Oct. 22, 2026

(54) SMART COUCHTOP EXTENSION CONFIGURED TO BE RELEASABLY COUPLED TO A COUCHTOP BASE STATION

(71) Applicant: ORFIT INDUSTRIES, Wijnegem (BE)

(72) Inventors: Steven CUYPERS, Wijnegem (BE); Emilie CUYPERS, Wijnegem (BE); Konstantinos GIANNADAKIS, Wijnegem (BE)

(21) Appl. No.: 19/122,452

(22) PCT Filed: Oct. 23, 2023
(86) PCT No.: PCT/EP2023/079491

§ 371 Date: Apr. 18, 2025

(30) Foreign Application Priority Data
Oct. 21, 2022 (BE) 2022/5850

(51) Int. Cl. A61G 7/05

(52) U.S. Cl. CPC A61G 7/05

(57) ABSTRACT

A couchtop extension configured to be releasably coupled to a couchtop base station and configured to support a patient during medical diagnosis or treatment is disclosed. The couchtop extension comprises a panel extending between a first longitudinal end and an second longitudinal end with a part of coupling means for releasably coupling the couchtop extension panel to the couchtop base station. The couchtop extension further comprises an impact detection unit attached to the part of the coupling means which is provided on the couchtop extension, the impact detection unit being configured for detecting impact between the panel and a foreign object. The couchtop extension further comprises a power supply attached to the part of the coupling means which is provided on the couchtop extension, the power supply unit being configured to power the impact detection unit at least whilst the couchtop extension is not coupled to the couchtop base station.

### TECHNICAL FIELD

The present invention relates to a couchtop extension configured to be releasably coupled to a couchtop base station. The couchtop extension is configured to support, i.e. hold, a patient during medical diagnosis or treatment. In embodiments, the couchtop extension is configured to support, a patient in a magnetic field or in a radiation zone during medical diagnosis or treatment, in particular by holding the couchtop extension, on which lies the patient, in said magnetic field or in said radiation zone. The present invention also relates to an assembly of a couchtop extension and a couchtop base station and/or a docking station. The present invention furthermore relates to the use of the couchtop extension and to the use of the assemblies.

### BACKGROUND OF THE INVENTION

Couchtop extensions and couchtop base stations are known from the prior art, such as from patent publication EP3823578 wherein the couchtop extension and the couchtop base station are respectively referred to as the extension panel and the patient support panel with pedestal.

Typically, a medical facility has a limited number of couchtop base stations and a large number of couchtop extensions. Couchtop base stations in medical facilities are found in treatment/diagnosis rooms. They are typically mounted on robotic arms which correctly position the patient for a treatment or a diagnosis. Therefore, the number of couchtop base stations is limited by the number of treatment machines that a medical facility has. The number of couchtop extensions is typically higher, as individual couchtop extensions serve different purposes: different patient sizes (such as pediatric and adult couchtop extensions) and different types of treatments (such as cranial or extra cranial treatment). Couchtop extensions are not firmly attached to a machine, thus they regularly have to be moved from a storage facility towards a couchtop base station or towards a docking station. The latter is a storage device in which the couchtop extension can be temporarily stored and in an embodiment of the present invention for example simultaneously charged (e.g. forming a charging station). It is unfortunate, but yet not uncommon, that during said transport the couchtop extensions free fall on the floor from a height, collide with the treatment machines, or hit other foreign objects, such as door frames. Such impacts between the couchtop extension and a foreign object result in a degraded performance of the couchtop extension. Impact on the couchtop extension can also occur when the couchtop extension is not being transported, for example when the couchtop extension is placed against a wall and somebody collides against it. In general, impacts on the couchtop extension when the couchtop extension is not coupled, i.e. is not coupled to the couchtop base station or to the docking station, should be avoided because they damage the couchtop extension. These impacts are referred to as uncoupled impacts. The inventors have found that it is important to be aware of such uncoupled impacts in order to timely service the couchtop extensions, for example by means of well-timed preventive maintenances, or even part replacement. At present, there is no way to use uncoupled impact knowledge when servicing couchtop extensions.

### DESCRIPTION OF THE INVENTION

It is the aim of the present invention to provide a couchtop extension which enables better servicing by taking into account uncoupled impacts on the couchtop extension.

To that end, the present invention provides a couchtop extension according to the first claim. As stated before, the couchtop extension is configured to be releasably coupled to a couchtop base station for example mounted on a pedestal or a robotic arm. The couchtop extension is configured to support a patient during medical diagnosis or treatment. In an embodiment, the couchtop extension is arranged to support the patient in a magnetic field or in a radiation zone during medical diagnosis or treatment, in particular by holding the couchtop extension, on which lies the patient, in said magnetic field or in said radiation zone. The medical diagnosis could for example be the medical imaging prior to a medical treatment. The magnetic field is for example present in case the medical diagnosis comprises an MRI machine. The radiation zone is for example a zone in which a patient is placed when he/she is being irradiated by means of radiation such as X-ray radiation, gamma radiation, proton radiation or alpha particle radiation for the purposes of medical diagnosis or treatment. The couchtop extension comprises a panel extending between a first longitudinal end and a second longitudinal end. The couchtop extension comprises a part of coupling means for releasably coupling the couchtop extension panel to the couchtop base station. The first longitudinal end and the second longitudinal are also referred to as respectively the cranial end and the caudal end of the panel. Such a couchtop extension and couchtop base station are for example known from patent publication EP3823578, which is therefore incorporated herein by reference. The part of the coupling means provided on the couchtop extension could also be suitable for releasably coupling the couchtop extension panel to the docking station. The couchtop extension according to the present invention further comprises an impact detection unit attached to the panel. The impact detection unit is configured for detecting impacts between the panel and a foreign object such as a floor or a door frame. The couchtop extension further comprises a power supply attached to the panel, the power supply unit being configured to power the impact detection unit at least whilst the couchtop extension is not coupled to the couchtop base station, preferably also when the couchtop extension is not coupled to the docking station, preferably when the couchtop extension is uncoupled in general. This enables to detect “uncoupled impacts” between the couchtop extension and the foreign object.

According to an embodiment of the present invention, the impact detection unit comprises a sensor arranged to sense a parameter indicative of an impact between the panel and the foreign body. Preferably, the impact detection unit also comprises a data storage medium arranged to store the sensed parameter. According to an embodiment of the present invention, the impact detection unit further comprises a controller. In an embodiment, the controller is arranged to pre-process the sensed parameter. The controller is for example arranged to determine from the sensed parameter whether an impact has occurred. The controller is preferably also arranged to store in the data storage medium an indication of the occurred impact. The information stored in the data storage medium, i.e. the sensed parameter and the pre-processed sensed parameter, e.g. the indication of the occurred impact, is further also referred to as “impact information”.

According to an embodiment of the present invention, the sensor is an accelerometer arranged to sense acceleration of the panel. Preferably, in addition or alternative to the acceleration of the panel, the accelerometer measures gyroscopic data related to the panel. Preferably, the aforementioned controller determines that an impact has occurred when the sensed acceleration exceeds a predetermined threshold.

According to an embodiment of the present invention, the power supply unit comprises a battery. Preferably, the battery is arranged to be charged upon coupling the couchtop extension to the couchtop base station.

According to an embodiment of the present invention, the couchtop extension is arranged to transmit the information stored in the data storage medium, also referred to as the “impact information”, to the couchtop base station. Preferably, the information is transmitted upon coupling the couchtop extension with the couchtop base station. Alternatively, or additionally, the information is transmitted wirelessly between the couchtop extension and the couchtop base station upon the couchtop extension and the couchtop base station being proximate to one another. The couchtop extension and the couchtop base station are for example proximate to one another when they are within ten meters from each other, preferably within five meters from each other.

According to an embodiment of the present invention, the couchtop extension is further arranged to be coupled to a docking station. The docking station is a storage device in which the couchtop extension, or preferably multiple couchtop extensions, can be temporarily stored. In an embodiment of the present invention, the battery is arranged to be charged upon coupling the couchtop extension to the docking station. This makes the docking station a charging station. According to an embodiment of the present invention, the couchtop extension is arranged to transmit the information stored in the data storage medium to the docking station. In an embodiment the information is transmitted upon coupling the couchtop extension with the docking station. Alternatively, or additionally, the information is transmitted wirelessly between the couchtop extension and the docking station upon the couchtop extension and the docking station being proximate to one another. The couchtop extension and the docking station are for example proximate to one another when they are within ten meters from each other, preferably within five meters from each other.

According to an embodiment of the present invention, the couchtop extension further comprises a communication module. The communication module is preferably arranged to communicate wirelessly with a communication module of another couchtop extension, further referred to as the second couchtop extension to differentiate from the preceding, first, couchtop extension. The couchtop extension is preferably arranged to wirelessly transmit the information stored in the data storage medium of the first couchtop extension to the second couchtop extension upon the two couchtop extensions being proximate. The first couchtop extension and the second couchtop extension are for example proximate to one another when they are within ten meters from each other, preferably within five meters from each other.

According to an embodiment of the present invention, the coupling means comprise a part provided on the couchtop extension and a part provided on the couchtop base station or on the docking station. Preferably, the part of the coupling means which is provided on the couchtop extension, is provided on the second longitudinal end of the panel. Preferably, the part of the coupling means which is provided on the couchtop base station comprises one of a) a tab preferably delimited by an upper surface and a lower surface, and b) a cavity preferably delimited by an upper surface and a lower surface. The part of the coupling means which is provided on the couchtop extension comprises the other one of the tab and the cavity. The cavity is configured to receive the tab upon coupling the couchtop extension to the couchtop base station or docking station such as to support the couchtop extension with the couchtop base station or docking station. In an example, the part of the coupling means which is provided on the couchtop base station or docking station comprises the tab and the part of the coupling means which is provided on the couchtop extension comprises the cavity.

According to an embodiment of the present invention the sensor of the impact detection unit, and preferably the entire impact detection unit, is provided on the part of the coupling means which is provided on the couchtop extension. According to an embodiment of the present invention the power supply is provided on the part of the coupling means which is provided on the couchtop extension.

According to an embodiment of the present invention, the panel is made of a radiolucent material such that the interference of the medical radiation by the panel is reduced. The part of the coupling means which is provided on the couchtop extension could for example be made of a non-radiolucent material.

It is a further object of the present invention to provide an assembly comprising at least one couchtop extension as described above, and further comprising a couchtop base station and/or a docking station as described above. It is a further object of the present invention to provide multiple couchtop extensions as described above, preferably in an assembly as described above wherein a couchtop base station and/or a docking station is also provided. The multiple couchtop extensions preferably comprise the communication module as described above. The communication modules enable the couchtop extensions to communicate wirelessly with each other.

In an embodiment, the couchtop base station or the docking station comprises a data storage medium for storing the above mentioned impact information directly in the couchtop base station or docking station. The couchtop base station or docking station could also comprise a processor for pre-processing the impact information, for example by applying data reduction on the impact information. The user could then for example directly access the impact information or the pre-processed impact information from the data storage medium in the couchtop base station or docking station. Alternatively, the data storage medium could be external to the base station or docking station, and the base station or docking station could transmit the impact information, or a pre-processed version of the impact information, to the external data storage medium. The external data storage medium could for example be a cloud-based data hosting service. The user could receive said impact information or said pre-processed impact information by directly consulting the external data storage medium. In an embodiment, it is not the user of the couchtop extension that directly consults the external data storage medium, but it is an external company that directly consults the external data storage. The external company is for example the manufacturer of the couchtop extensions or a contractually appointed maintenance firm. The external company can subsequently inform the user of the couchtop extension of the improper use, for example by planning a preventive maintenance. According to an embodiment of the present invention, the couchtop base station or docking station comprises a communication module arranged to send the impact information to the external data storage medium such as to a cloud-based hosting service. As described above, the communication module can also send pre-processed impact information to the external data storage medium.

It is a further object of the present invention to provide for a method for detecting an impact between a couchtop extension and a foreign object. The method comprises providing a couchtop extension as described above, and detecting an impact between the couchtop extension and a foreign body by means of the impact detection unit powered by the power supply unit as described above. Preferably, the step of detecting an impact between the couchtop extension and a foreign body by means of the impact detection unit powered by the power supply unit, takes place whilst the couchtop extension is not coupled to a couchtop base station or a docking station, as described above, i.e. to detect “uncoupled impacts”. In an embodiment, the above mentioned assembly of at least one couchtop extension and a couchtop base station and/or a docking station is provided and the method comprises a step of charging the battery of the couchtop extension upon coupling the couchtop extension to the couchtop base station or to the docking station. In an embodiment, the above mentioned assembly of at least one couchtop extension and a couchtop base station and/or docking station is provided, and the method comprises the step of the couchtop extension transmitting the information stored in the data storage medium to the couchtop base station and/or to the docking station. For example, the couchtop extension transmits the information stored in the data storage medium to the couchtop base station upon coupling the couchtop extension with the couchtop base station and/or the couchtop extension transmits the information stored in the data storage medium to the docking station upon coupling the couchtop extension with the docking station. Alternatively, or additionally, the couchtop extension for example wirelessly transmits the information stored in the data storage medium to the couchtop base station upon the couchtop extension and the couchtop base station being proximate, and/or the couchtop extension wirelessly transmits the information stored in the data storage medium to the docking station upon the couchtop extension and the docking station being proximate. The couchtop extension is for example proximate to the couchtop base station or docking station when they are within ten meters from each other, preferably within five meters from each other. In an embodiment, a first and second couchtop extension are provided, each having a communication module as described above, and the method comprises the step of the first couchtop extension wirelessly transmitting the information stored in the data storage medium of the first couchtop extension to the second couchtop extension upon the two couchtop extensions being proximate. The couchtop extensions are for example proximate to one another when they are within ten meters from each other, preferably within five meters from each other. Preferably, the second couchtop extension subsequently transmits the information stored in the data storage medium of the first and second couchtop extension to the couchtop base station and/or the docking station, as described above. According to an embodiment of the present invention, the communication module of the couchtop base station and/or the docking station sends the impact information to an external data storage medium such as a cloud-based hosting service.

### FIGURES

FIG. 1 shows a perspective view of a couchtop extension according to an embodiment of the present invention, wherein the couchtop extension is about to be coupled to the couchtop base station.

FIG. 2 shows a schematic overview of some components in the couchtop extension of FIG. 1.

FIG. 3 shows how multiple couchtop extensions such as the one shown in FIG. 1, can communicate between each other.

FIG. 4 shows a perspective view of the couchtop extension shown in FIG. 1 coupled to a docking station.

### BRIEF DESCRIPTION OF THE FIGURES

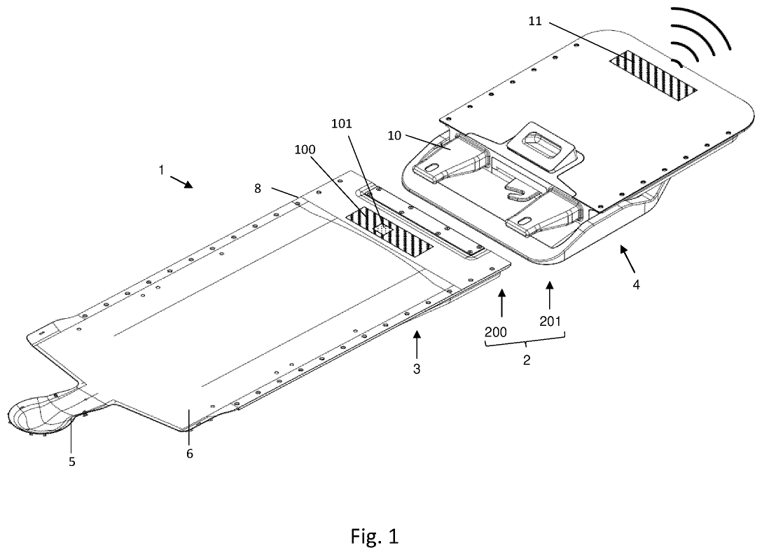

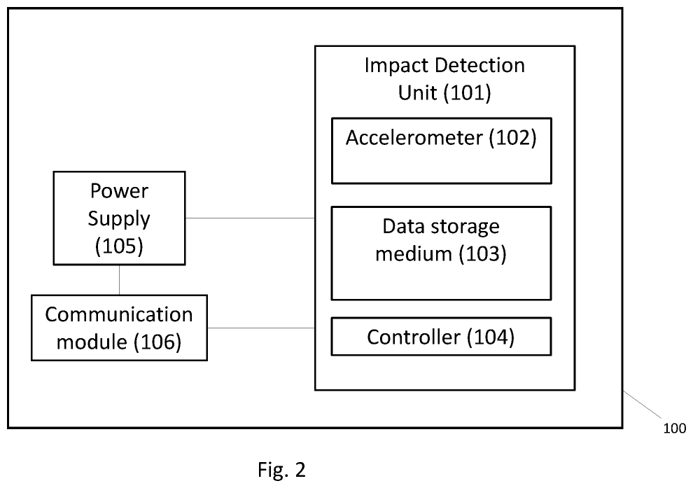

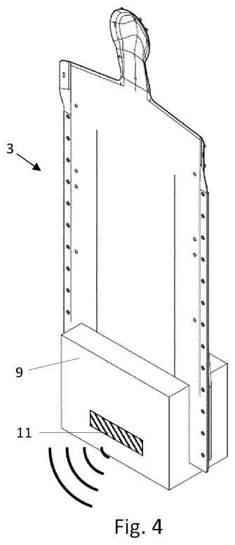

FIG. 1 shows an assembly 1 of a couchtop extension 3 and a couchtop base station 4. The couchtop extension is configured to be releasably coupled to the couchtop base station. The couchtop base station is typically attached to a pedestal or to a robotic arm. The couchtop extension is arranged to support a patient in a magnetic field or in a radiation zone during medical diagnosis or treatment, in particular by holding the couchtop extension, on which lies the patient, in said magnetic field or in said radiation zone. The couchtop extension comprises a radiolucent panel 6 extending between a first longitudinal end 5 and an second longitudinal end 8. The second longitudinal end 8 of the panel 6 is provided with a part 200 of coupling means 2 for releasably coupling the couchtop extension panel to the couchtop base station. Such a couchtop extension and couchtop base station are for example known from patent publication EP3823578, which is therefore incorporated herein by reference. The part 200 of the coupling means which is provided on the couchtop extension is also suitable for releasably coupling the couchtop extension panel to the docking station 9 as is shown in FIG. 4. In the shown embodiment, the part 200 of the coupling means which is provided on the couchtop extension comprises two cavities. The part 201 of the coupling means which is provided on the couchtop base station or on the docking station are tabs 10 arranged to be received into the cavities of the couchtop extension. The couchtop extension according to the present invention further comprises an impact detection unit 101 attached to the part 200 of the coupling means which are provided on the couchtop extension. The impact detection unit is configured for detecting impacts between the panel and a foreign object such as a floor or a door frame. The impact detection unit 101 is provide in a receptacle 100 attached to the part 200 of the coupling means which is provided on the couchtop extension. As is shown in FIG. 2, the receptacle 100 of the couchtop extension further comprises a power supply 105, the power supply unit being configured to power the impact detection unit 101 whilst the couchtop extension is not coupled to the couchtop base station or to the docking station, i.e. when the couchtop extension is uncoupled. This enables to detect “uncoupled impacts” between the couchtop extension and the foreign object. The impact detection unit 101 comprises a sensor 102 arranged to sense a parameter indicative of an impact between the panel and the foreign body. In particular, the sensor is an accelerometer. The impact detection unit also comprises a data storage medium 103 arranged to store the sensed acceleration and gyroscopic data. The impact detection unit 101 further comprises a controller 104 arranged to determine from the sensed acceleration whether an impact has occurred. The controller is further arranged to store in the data storage medium an indication of the occurred impact. The controller determines that an impact has occurred when the sensed acceleration exceeds a predetermined threshold.

The power supply unit 105 comprises a battery arranged to be charged upon coupling the couchtop extension 3 to either the couchtop base station 4 or the docking station 9. The couchtop extension is arranged to transmit the information stored in the data storage medium, i.e. the impact information, to the couchtop base station and to the docking station. The information is transmitted upon coupling the couchtop extension with the couchtop base station or the docking station. Additionally, the information is transmitted wirelessly between the couchtop extension and the couchtop base station or docking station upon the couchtop extension and the couchtop base station or docking station being proximate to one another.

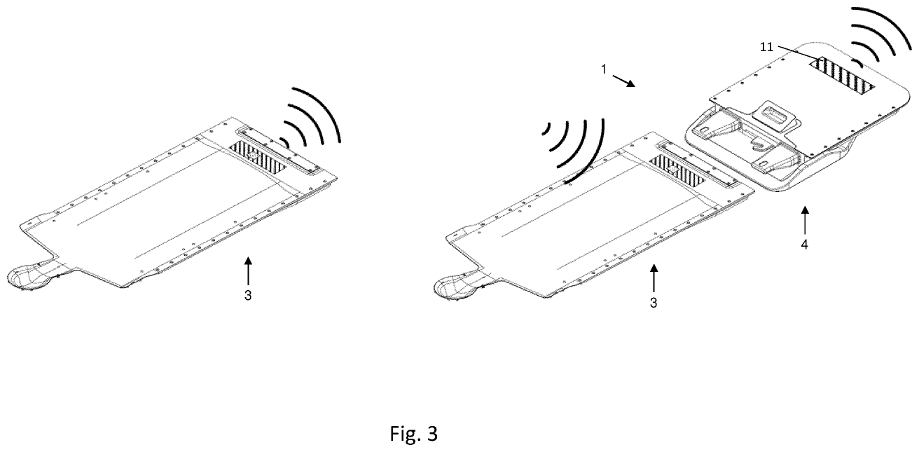

The couchtop extension 3 further comprises a communication module 106 arranged to communicate wirelessly with a communication module of another couchtop extension as is shown in FIG. 3. The left couchtop extension is arranged to wirelessly transmit the information stored in its data storage medium to the right couchtop extension upon the two couchtop extensions being proximate. The right couchtop extension subsequently wirelessly transmits the impact information of both couchtop extensions to a couchtop base station or a docking station.

The couchtop base station 4 and the docking station 9 each comprise a receptacle 11 comprising a data storage medium and a communication module. The former stores the impact information received from the couchtop extensions. The latter sends the impact information to an external data storage medium such as a cloud-based hosting service.

1. A couchtop extension configured to be releasably coupled to a couchtop base station and configured to support a patient during medical diagnosis or treatment, the couchtop extension comprising a panel extending between a first longitudinal end and a second longitudinal end, wherein the couchtop extension comprises a part of coupling means for releasably coupling the couchtop extension panel to the couchtop base station, wherein the couchtop extension further comprises an impact detection unit, the impact detection unit being configured for detecting impact between the panel and a foreign object, and wherein the couchtop extension further comprises a power supply, the power supply unit being configured to power the impact detection unit at least whilst the couchtop extension is not coupled to the couchtop base station.

2. The couchtop extension according to claim 1. wherein the couchtop extension is arranged for supporting the patient in a magnetic field or in a radiation zone during medical diagnosis or treatment.

3. The couchtop extension according to claim 1, wherein the impact detection unit comprises a sensor arranged to sense a parameter indicative of an impact between the panel and the foreign body, and a data storage medium arranged to store the sensed parameter.

4. The couchtop extension according to claim 3, wherein the impact detection unit comprises a controller arranged to determine from the sensed parameter whether an impact has occurred, and preferably arranged to store in the data storage medium an indication of the occurred impact.

5. The couchtop extension according to claim 4, wherein the sensor is an accelerometer arranged to sense acceleration of the panel.

6. The couchtop extension according to claim 5, wherein the controller determines that an impact has occurred when the sensed acceleration exceeds a predetermined threshold.

7. (canceled)

8. (canceled)

9. The couchtop extension according to claim 3, wherein the couchtop extension is arranged to transmit the information stored in the data storage medium, to the couchtop base station.

10. The couchtop extension according to claim 9, wherein the impact information is transmitted upon coupling the couchtop extension with the couchtop base station.

11.-16. (canceled)

17. The couchtop extension according to claim 3, wherein the couchtop extension further comprises a communication module arranged to communicate wirelessly with a communication module of another couchtop extension, wherein the couchtop extension is preferably arranged to wirelessly transmit the information stored in the data storage medium, to another couchtop extension upon the two couchtop extensions being proximate.

18. The couchtop extension according to claim 1, wherein the part of the coupling means which is provided on the couchtop extension comprises one of a tab and a cavity, arranged to couple with a part of the coupling means which is provided on the couchtop base station or docking station, the part of the coupling means which is provided on the couchtop base station or docking station comprising the other one of the tab and the cavity, wherein the cavity is configured to receive the tab upon coupling the couchtop extension to the couchtop base station or docking station such as to support the couchtop extension with the couchtop base station or docking station.

19. The couchtop according to claim 1, wherein the impact determination unit is provided on the part of the coupling means which is provided on the couchtop extension.

20. The couchtop according to claim 1, wherein power supply is provided on the part of the coupling means which is provided on the couchtop extension.

21. The couchtop according to claim 1, wherein the part of the coupling means which is provided on the couchtop extension, is provided on the second longitudinal end of the panel.

22. The couchtop according to claim 1, wherein the panel is made of a radiolucent material such that the interference of the medical radiation by the panel is reduced.

23. An assembly comprising at least one couchtop extension according to claim 1, and further comprising a couchtop base station and/or a docking station.

24. The assembly according to claim 23, wherein the couchtop base station and/or the docking station comprises a communication module arranged to send the impact information to an external data storage medium such as a cloud-based hosting service.

25. The assembly according to claim 23, wherein multiple couchtop extensions are provided, wherein the multiple couchtop extensions comprise a communication module arranged to communicate wirelessly with a communication module of another couchtop extension, wherein the couchtop extension is preferably arranged to wirelessly transmit the information stored in the data storage medium, to another couchtop extension upon the two couchtop extensions being proximate.

26. A method of detecting an impact between a couchtop extension and a foreign object, the method comprising providing a couchtop extension according to claim 1, and detecting an impact between the couchtop extension and a foreign body by the impact detection unit powered by the power supply unit.

27. The method according to claim 26, wherein the step of detecting an impact between the couchtop extension and a foreign body by the impact detection unit powered by the power supply unit takes place whilst the couchtop extension is not coupled to a couchtop base station or a docking station.

28.-34. (canceled)
